(19) United States
(12) Patent Application Publication
(10) Pub. No.: US 2003/0161708 A1
(43) Pub. Date: Aug. 28, 2003

(54) Triangulated mobile gantry crane

(76) Inventor: Roger L. Johnston, Muskego, WI (US)

Correspondence Address: Timothy E. Newholm, BOYLE, FREDRICKSON, NEWHOLM, STEIN & GRATZ S.C., 250 Plaza, Suite 1030, 250 East Wisconsin Avenue, Milwaukee, WI, 53202, US

(21) Appl. No.: 10/080,982

(22) Filed: Feb. 22, 2002

(51) Int. Cl. B60P 3/00

(52) U.S. Cl. 414/460

(57) ABSTRACT

A triangulated gantry includes a front ground-supported boom positioned laterally between and longitudinally remote from left and right rear ground-supported booms of the machine. The booms are functionally interconnected by a system of horizontal beams that may form an at least generally triangular shape when viewed in top plan. The resultant gantry is extremely stable and extremely maneuverable when compared to traditional four boom gantries. Maneuverability may be enhanced further by configuring each of the bases of the booms so as to be steerable through an angle of at least 360° with respect to the remainder of the boom. One or more of the horizontal beams may be extendible and retractable to increase and reduce the size of the footprint of the machine, permitting the machine to maneuver towards a load through tight spaces and to subsequently expand to straddle the load.

### BACKGROUND OF THE INVENTION

1. Field of Invention

The invention relates to gantries and, more particularly, relates to a mobile gantry configured to straddle, lift, and transport heavy loads in confined spaces. The invention additionally relates to a method of lifting and transporting a load using such a gantry.

2. Discussion of the Related Art

Mobile gantry cranes, often known simply as “gantries” are well known for lifting and transporting heavy loads (on the order of 20 tons or heavier). The typical gantry includes four booms in which two sets of booms are spaced longitudinally from one another to define front and rear ends of the machine. Each set includes left and right booms positioned so as to flank a lift area containing a load. Each boom comprises a mobile base and a vertically extendible lift leg mounted on top of the base. A longitudinal lift beam straddles the upper ends of the lift legs of each boom set. The booms on each side of the machine may be coupled to one another by additional longitudinal beams. A load can be coupled to the lift beams via suitable rigging, whereupon coextension and retraction of the booms raises and lowers the load.

The traditional four boom gantry exhibits distinct drawbacks under at least some operating conditions. For instance, it has a very wide wheel base both laterally and longitudinally and, therefore, necessarily has a very wide turning radius. It is therefore difficult to maneuver in confined spaces such as within buildings or within crowded yards. As a result, it is often difficult to position the gantry over loads, and the gantry cannot access a load that is positioned closely adjacent other loads or other structures. The maneuverability problem is exacerbated by the fact that the wheels of most gantries can be steered through only a limited angle of, e.g., 90°, further limiting the effective turning radius of the machine. In addition, because the lift beams of the traditional gantries are of a fixed, invariable length, the effective area or “footprint” of the machine cannot be contracted to permit the machine to fit through doors or other tight spaces and subsequently expanded to permit the machine to straddle a load.

The 4-point support provided by the typical boom also is relatively unstable when the machine travels over uneven surfaces because the four separate booms may tend to rock when positioned out of plane, much like the legs of a 4-legged chair will rock when the chair is supported on an uneven surface. Some systems attempt to enhance stability by connecting the lift beams to the upper ends of the lift legs by pins that permit the lift beams to pivot about a horizontal axis, thereby accommodating limited relative vertical movement between the individual booms of the system. However, these pinned connections typically permit only fore-and-aft pivoting of the lift beams. They do not accommodate relative side-to-side movement of the lift beams. This problem can be partially alleviated by coupling the lift beam to the lift leg by a ball and socket joint that permits limited lift beam movement in all directions. However, if surface unevenness exceeds the play provided by the ball and socket joints, the gantry may rock back and forth about the uneven booms. This rocking tendency is exacerbated by the relatively short wheel base provided by the relatively short (typically 4 feet) lateral spacing between the booms of each set.

The need therefore has arisen to provide a gantry that is capable of maneuvering in confined spaces.

The need has additionally arisen to provide a gantry that is relatively stable when compared to traditional 4-point gantries.

### SUMMARY OF THE INVENTION

In accordance with a first aspect of the invention, the above-identified needs are met by providing a triangulated mobile gantry comprising first, second, and third booms, each of which comprises a mobile base and a vertically extendible lift leg supported on the base. In order to provide the desired triangulation effect, the first boom is positioned laterally between and longitudinally remote from the second and third booms. The gantry additionally comprises a plurality of horizontal beams that functionally interconnect the lift legs.

The beams preferably, but not necessarily, include first, second, and third beams functionally interconnecting the upper ends of the lift legs to form an at least essentially triangular shape when viewed in top plan. In order to permit the gantry to be extended longitudinally to accommodate the load, the first and second beams may be extendible to increase the spacing between the first and second booms and the first and third booms, respectively. Similarly, the third beam may be extendible to increase the spacing between the second and third booms in order to permit the gantry to selectively contract laterally to fit through tight spaces and to expand to straddle the load.

Maneuverability may be increased further by configuring each of the boom bases to be rotatable through an angle of at least 360° relative to the associated lift leg.

In accordance with another aspect of the invention, a method of lifting a heavy load comprises moving a mobile triangulated gantry over a load by straddling the load with an open front end of the gantry and positioning the load longitudinally between the open front end and closed rear end, the rear end of the gantry comprising a first boom positioned adjacent a lateral centerline of the gantry, the open front end comprising second and third booms disposed on opposite sides of the lateral centerline. Then, at least one of first, second, and third horizontal beams is coupled to the load (the first, second, and third horizontal beams functionally interconnect the first, second, and third booms to one another). Then the first, second, and third booms are extended to lift the load.

In order to enhance maneuverability while being able to accommodate large loads, additional steps may include 1) extending the third beam prior to the moving step so as to increase the spacing between the second and third booms sufficiently to permit the front end of the gantry to straddle the load and/or extending the first and second beams to increase the length of the gantry. Maneuverability may be enhanced still further by steering the vehicle by rotating the base of at least one of the booms through an angle of at least 360° with respect to the associated lift leg.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a side elevation view of a triangulated gantry constructed in accordance with a preferred embodiment of the present invention;

FIG. 2 is a top plan view of the gantry of FIG. 1, illustrating the gantry in a fully-expanded state thereof;

FIG. 3 is a top plan view of the gantry, illustrating the gantry in a fully-contracted state thereof;

FIG. 4 is a front elevation view of a front boom of the gantry;

FIG. 5 is a sectional elevation view of the base of one of the booms, taken generally along the lines 5-5 in FIG. 1;

FIG. 6 is a sectional plan view of the base of tone of the booms, taken generally along the lines 6-6 in FIG. 1;

FIG. 7 is a fragmentary end elevation view of the upper portion of a front boom of the gantry and of the front ends of the lift beams;

FIG. 8 is a sectional plan view of one of the lift beams of the gantry, taken generally along the lines 8-8 of FIG. 1;

FIG. 9 is sectional end elevation view taken generally along the lines 9-9 in FIG. 8; and

FIG. 10 is a sectional elevation view of the rear cross beam of the gantry, taken generally along the lines 10-10 of FIG. 1.

### DETAILED DESCRIPTION OF THE PREFERRED EMBODIMENTS

1. Resume

Pursuant to the invention, a gantry is provided that can be easily maneuvered through confined spaces and that is extremely stable, even when traveling over uneven ground and lifting heavy loads (on the order of 20-500 tons). The gantry preferably includes a front boom positioned laterally between and longitudinally remote from left and right rear booms of the machine. The booms are functionally interconnected by a beam network that may include first, second, and third horizontal beams that form an at least generally triangular shape when viewed in top plan. The resulting triangulated gantry is extremely stable and extremely maneuverable when compared to traditional four-boom gantries. Maneuverability is increased further by configuring each of the wheels or other mobile supports for the booms so as to be steerable through an angle of at least 360°. Gantry versatility can be enhanced by configuring at least one, and possibly all, of the horizontal beams so as to be extendible and retractable to increase and reduce the size of the footprint of the machine, thereby permitting the machine to maneuver towards a load through tight spaces and to subsequently expand to straddle the load.

2. Construction of Gantry

Referring now to the drawings and initially to FIGS. 1-3 in particular, a gantry 20 constructed in accordance with an exemplary embodiment of the invention includes three ground-supported booms 20, 24, and 26 functionally interconnected by a system of 5 horizontal beams. The term “functionally interconnected” as used herein means that the beams are supported on the three booms 22, 24, and 26 to effectively form a unitary vehicle. However, all of the beams need not be supported directly on a boom at each end.

Nor must the beams be directly connected to each other to form a triangle. In fact, in the illustrated embodiment in which the beam network consists of left and right lift beams 28 and 30 and a rear cross beam 32, the cross beam 32 is supported on the lift beams 28 and 30 somewhat in front of their rear ends rather than directly on the corresponding booms 24 and 26, and the front ends of the lift beams 28 and 30 do not converge at a true point.

The expression “functionally interconnected” and its equivalents should therefore be construed broadly. (Similarly, terms such as “front,” “rear,” “longitudinal,” “lateral,” “left,” “right,” etc., as used herein, are used only as a frame of reference and are not intended to be limiting.)

In the illustrated embodiment, a single front boom 22 is positioned at least adjacent and preferably on the lateral centerline of the machine 20, and left and right rear booms 24 and 26 are positioned on opposite sides of the lateral centerline of the machine. 20 Left and right lift beams 28 and 30 connect the front boom 22 to the left and right rear booms 24 and 26, respectively. A rear cross beam 32 connects rear end portions of the left and right lift beams 28 and 30 to one another.

Referring to FIGS. 2-4, an operator's platform 34 is mounted on front of the front boom 22. The operator's platform 34 supports an internal combustion engine 36, a hydraulic pump 38, at least part of a control valve assembly 40, and an operator's workstation including operator's controls 42. The engine 36 preferably comprises a propane engine. The pump 38 may comprise any pump that can generate sufficient hydraulic pressure under power of the engine 36 to operate all hydraulic components of the gantry 20. The operator can manipulate the controls 42 to operate the engine 36, the pump 38, and the control valve assembly 40 to control the flow of hydraulic fluid between the pump 38 and the remaining hydraulically powered components of the gantry 20.

As best seen in FIGS. 1 and 4, each of the booms 22, 24, and 26 comprises a mobile ground-supported base 50, 50a and a vertically extendible lift leg 52, 52a mounted on the base. Except for the fact that the lift leg 52a of the front boom 22 is of a heavier duty construction than the lift legs 52 of the rear booms 24 and 26, and except for the fact that the connections of the upper ends of the lift legs to the associated beams are different, all three lift legs are of identical construction. Hence, referring to FIG. 4 by way of example, the lift leg 52a includes a stationary inner square tube 54a and an outer square tube 56a. The outer tube 56a surrounds the inner tube 54 and is configured for vertical extension and retraction relative to the inner tube 54a. A hydraulic cylinder 58 is positioned within the lift leg 52a with its lower, rod end affixed to the base of the lift leg 52a and its upper, barrel end affixed to the upper end of the outer tube 56. Hence, retraction and extension of the cylinder 58 leads to extension and retraction of the outer tube 56a relative to the inner tube 54a in a manner which is, per se, well known. The resulting system has an effective lift stroke of about 4½′, permitting the beams 28, 30, and 32 to be lifted from a minimum height of about 8′ to a maximum height of about 12½ feet in the illustrated embodiment. If a greater lift range is required, the illustrated single stage cylinder 58 could be replaced by a multistage cylinder, and/or supplemented with a so-called “manual section” of the type described in U.S. Pat. No. 6,330,951 (the '951 patent), the subject matter of which is hereby incorporated by reference.

A safety brake couples the inner and outer tubes 54 and 56 to lock the tubes together and prevent unintended lowering of the gantry 20 in the event of hydraulic pressure loss. A suitable safety system is a cam-lock system 60 of the type disclosed in the '951 patent.

Referring to FIGS. 5 and 6, the base 50 of each of the rear booms 24 and 26 includes a frame 62, a mobile support 64 supporting the frame 62 on the ground, a motor 66 for driving the support 64 so as to propel the boom, and a power steering assembly 68 for changing the orientation of the base 50 relative to the lift leg 52 to steer the boom. The support 64 could comprise a track or crawler. In the illustrated embodiment, however, the support 64 comprises a wheel. The wheel 64 is mounted on a drum 70 that is connected to a downwardly extending tubular extension 63 of the frame 62 by the motor 66. The motor 66 preferably is a planetary drive type hydrostatic motor. As is typical with drives of this type, the control valve assembly 40 controls the flow of hydraulic fluid to and from the hydrostatic motor 66 to drive the wheel 64 to rotate either forward or reverse relative to the frame 62.

Still referring to FIGS. 5 and 6, the power steering assembly 68 of the left rear boom 24 couples the frame 62 to an annular base 72 of the lift leg 52 so as to permit the frame 62 and wheel 64 to be rotated through an angle of at least 360°, and preferably infinitely, relative to the base 72 of the lift leg 52, thereby providing an infinite steering range. The power steering system 68 includes a worm gear drive 74 and a driven annular worm gear 76. The worm gear drive 74 is fixed to the upper end of the frame 62 adjacent the worm gear 76. The worm gear 76 is bolted to the upper end of the frame 62 in meshing engagement with the worm gear drive 74. The worm gear 76 is also rotatably borne against the base 72 of the lift leg 52 via gear bearings 78. Hydraulic fluid flow to and from the worm drive 74 is facilitated by a hydraulic swivel 80 positioned within the annualar worm gear 76 and the annular lift leg base 72 and bolted to the top of the frame 62. With this arrangement, the worm gear drive 74 can be operated to drive the worm gear 76 to rotate the frame 62 relative to the lift leg base 72 through a potentially infinite angle.

Referring back to FIG. 4, the base 50a of the front boom 22 differs from the bases 50 of the rear booms 24 and 26 in that it is larger than the bases 50 of the rear booms 24 and 26 in recognition of the fact that the boom 22 bears a substantially greater proportion of the overall weight of the machine than the booms 24 and 26. In addition, rather than incorporating a single wheel, the base 50a is supported on the ground via a pair of wheels 64a, 64b, each driven by a dedicated planetary drive type hydrostatic motor 66a, 66b.

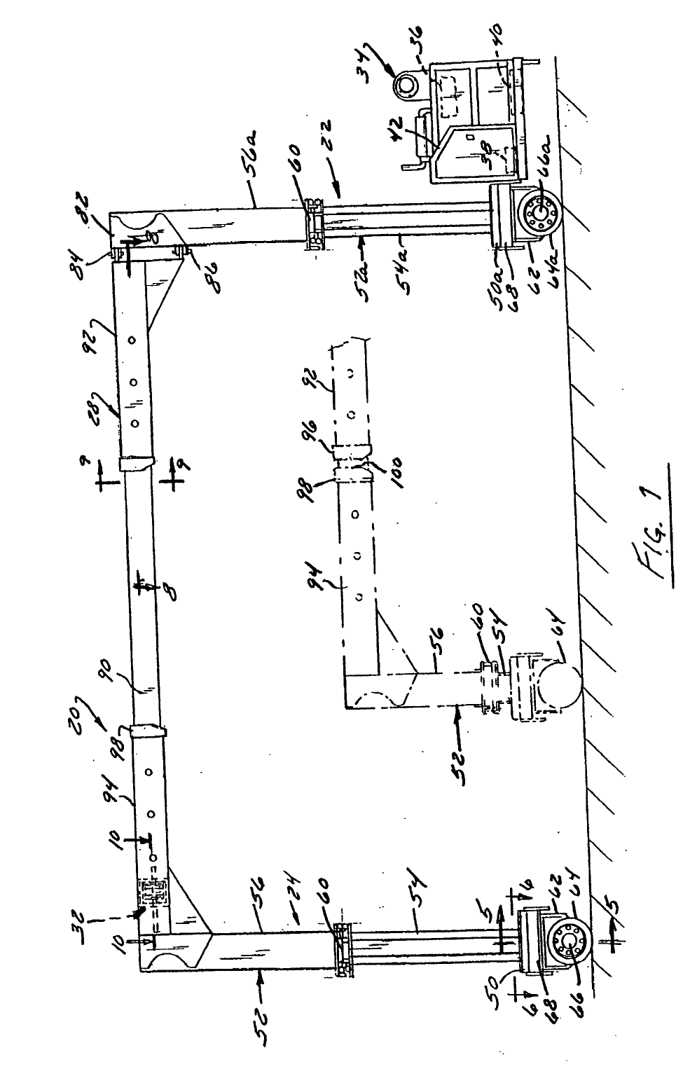

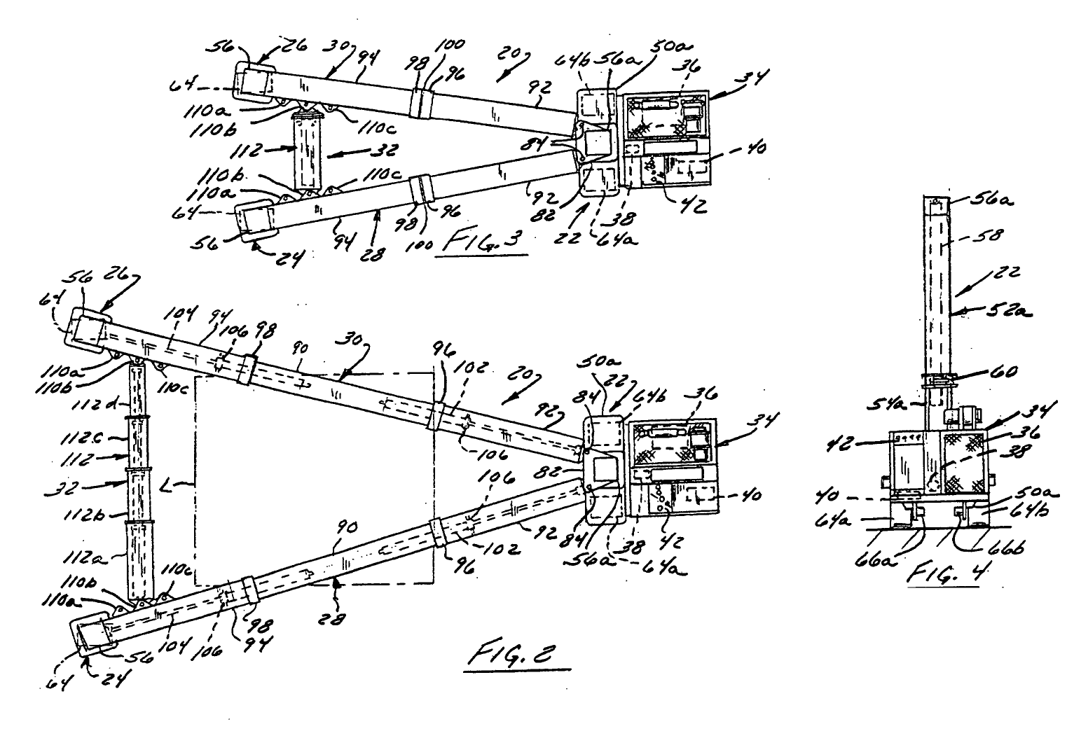

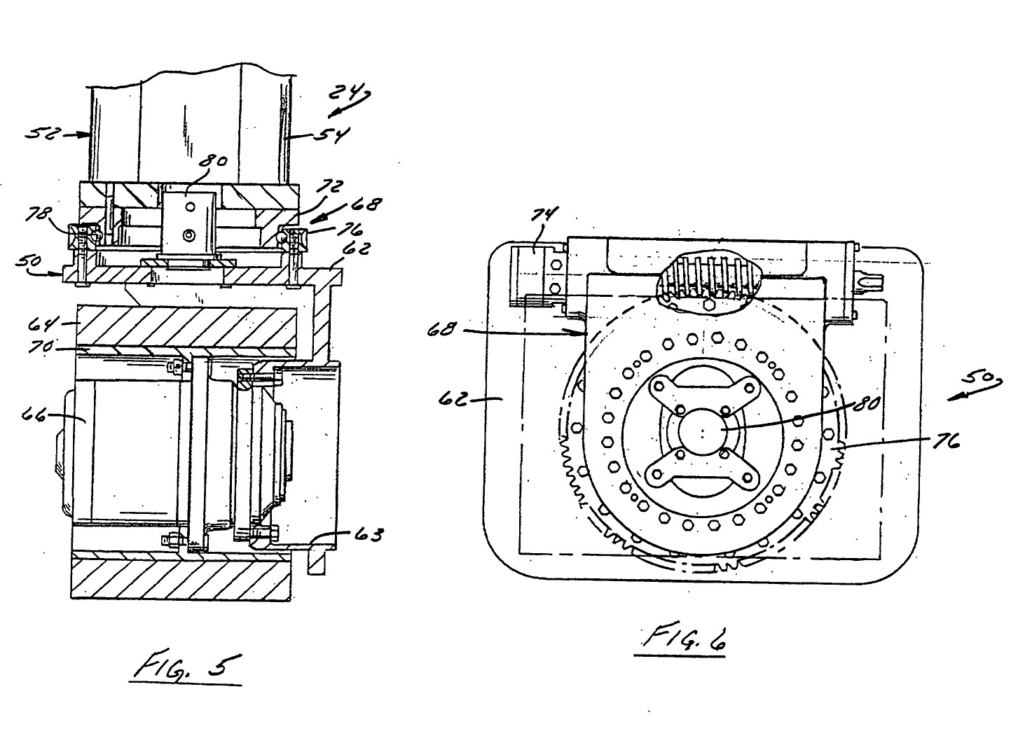

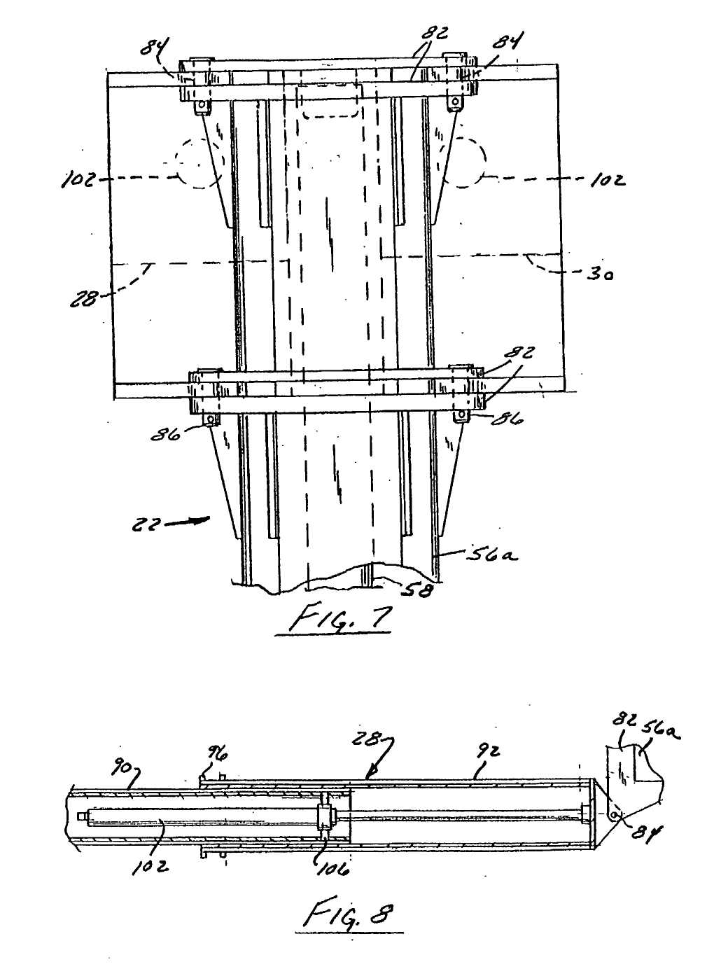

Referring again to FIGS. 1-3, the left and right beams 28 and 30 are both coupled directly to the front boom 22 and to an associated one of the rear booms 24 or 26. Due to the stable 3-point support provided by the triangulated gantry, the system need not accommodate relative horizontal movement between them and the booms. Hence the lift beam 28 is rigidly affixed the outer surface of the outer tube 56 of the boom 24 by welding or the like as best seen in FIG. 2. As best seen in FIGS. 2, 7, and 8, the front end of the lift beam 28 is connected to a mounting plate assembly 82 on the upper end of the outer tube 56a of the front boom 22 by a pair of vertically spaced pivot pins 84, 86 that allow the beam 28 to pivot about a vertical axis relative to the front boom 22. The right lift beam 30 is coupled to the right rear boom 26 and the front boom 22 in an identical manner

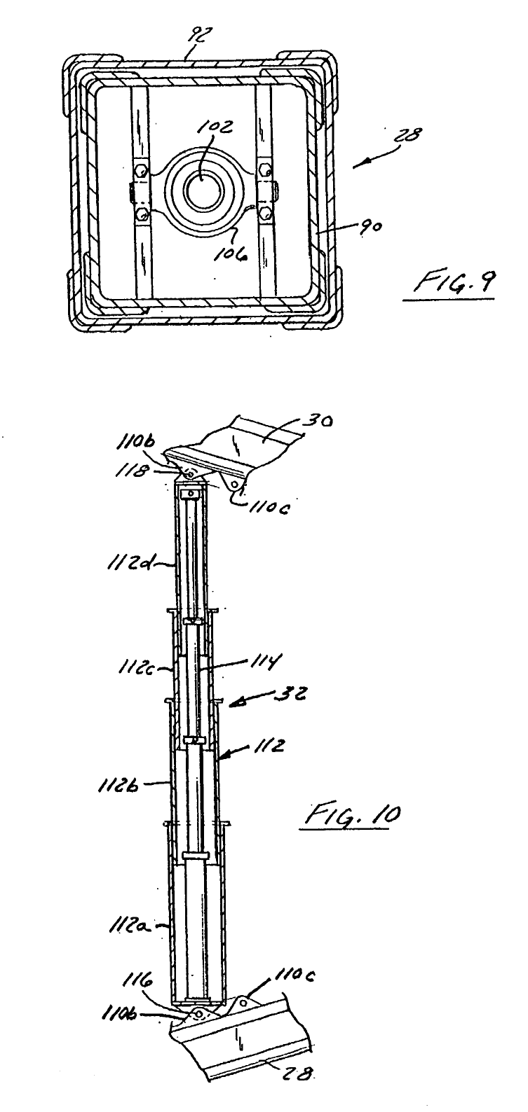

The left and right lift beams 28 and 30 could each comprise a conventional dimensionally invariable beam. In the illustrated embodiment, however, each of the beams 28 and 30 is configured to be extendible and retractable to vary the length of the machine 20. The beams 28 and 30 are shown in the extended state FIG. 2 and in solid lines in FIG. 1. They are shown in their retracted state in FIG. 3 and in phantom lines in FIG. 1. Extension and retraction is accommodated via the structure illustrated in FIGS. 8 and 9, which illustrate the left lift beam 28, it being understood that the right lift beam 30 is of identical construction. The beam 28 includes a square inner tube 90 and front and rear square outer tubes 92, 94. Each of the outer tubes 92 and 94 surrounds the inner tube 90 and is telescopically extendible and retractable with respect to the inner tube 90. The rear end of the front outer tube 92 and the front end of the rear outer tube 94 preferably terminate in facing plates 96 and 98 that leave a gap 100 between them as seen in FIG. 3 when the beam 28 is fully retracted. The gap 100 leaves room on the beam 28 for the connection of rigging (not shown) to the inner tube 90 for coupling to a load “L” (FIG. 2).

Referring to FIG. 2, front and rear hydraulic cylinders 102 and 104 are provided within the beam 28. The rod end of each cylinder 102 or 104 is affixed to the end of the associated outer tube 92 or 94. The barrel end of each cylinder 102 or 104 is affixed to the inner periphery of the inner tube 90 by a collar and strap arrangement 106 located near the rod as best seen in FIGS. 8 and 9. Each cylinder 102, 104 has a stroke of approximately 5′, permitting the beam 28 to be extended by 10′. In the illustrated embodiment, the inside clearance (defined by longitudinal spacing between the front of the front boom 22 and a plane extending between the rear of the rear booms 24 and 26) can be extended from a minimum of about 16′ to a maximum of about 26′ by extending and retracting of the cylinders 102 and 104.

It should be stressed that a variety of different arrangements could be provided for extending and retracting the beams 28 and 30 in place of the described telescoping tubes and cylinder arrangement. For instance, the cylinders 102 and 104 could be eliminated, and the tubes 90, 92, and 94 could be driven to telescope relative to one another via application of an external driving force and subsequently pinned or otherwise locked together. The tube arrangement could also be replaced with a multistage cylinder. Moreover, as indicated above, lift beam extension is not critical to the invention, and dimensionally invariable beams could be used in place of the beams 28 and 30 in some applications.

Referring again to FIGS. 2 and 3, the rear cross beam 32 is connectable to the rear portion each of the lift beams 28 and 30 at multiple discrete mounting locations 110a, 110b, 110c spaced along the rear end portion of the lift beam. This arrangement permits adjustment of the effective length of the gantry 20 to accommodate suspension of loads of different proportions at least partially from the rear cross beam 32. The rear cross beam 32 could be dimensionally invariable. However, it is even more preferably extendable and retractable so as to facilitate the ability of the machine 20 to selectively expand laterally (compare FIG. 2 to FIG. 3) to straddle the load L and contract laterally while decreasing its width upon demand to fit through doorways or narrow aisles. The cross beam 32 could take the same or similar form as the lift beams 28 and 30. However, in the illustrated embodiment in which the primary function of the rear cross beam 32 is to functionally couple the left and right lift beams 28 and 30 together and to stabilize the load L rather than to bear the brunt of the load, the rear cross beam 32 comprises a multistage cylinder arrangement best seen in FIG. 10. Specifically, beam 32 includes a multistage telescoping tube 112 containing a multistage cylinder 114. The tube 112 includes a left, outermost section 112a, intermediate sections 112b and 112c, and a right, innermost section 112d. The outermost section 112a is connected to a selected one 110b of the mounting locations on the left lift beam 28 by a pin 116. The innermost section 112d is connected to the corresponding mounting location 110b on the right lift beam 30 by another pin 118. The cylinder 114 has a rod end affixed to the end of the innermost section 112d and a barrel end affixed to the end of the outermost section 112a. The cylinder 114 can be extended and retracted to permit the inside lateral clearance of the machine 20 (as defined by the distance between planes passing through the inside most surfaces of the rear booms 24 and 26) to vary between 5-½′ and about 14-½′. The corresponding outside lateral clearance can be varied between about 10′ and about 19′.

3. Operation of Gantry

In use, the operator manipulates the controls 42 to maneuver the machine 20 towards the load L (FIG. 2), retracting the cylinders 102, 104, and 114 as necessary to permit the gantry 20 to fit through small relatively narrow doorways and/or relatively narrow paths while it is driven. As the machine 20 approaches the load L, the operator extends the cylinders 102 and 104 and/or the cylinder 114 to alter the length and/or width of the machine 20 as may be required to permit the gantry to straddle the load L. The gantry 20 is then positioned over the load L, and the left and right lift beams 28, 30 are coupled to the load L via suitable rigging such as straps, chains, cables, etc. The rear cross beam 32 may also be coupled to the load, if necessary. Next, the cylinders 58 are extended to extend the lift legs 52, 52a of the booms 22, 24, and 26 to lift the load L, and the gantry 20 is driven to the desired location. The cylinders 58 are then retracted to lower the load L, and the rigging is uncoupled from the load. The cylinders 102 and 104 and/or 114 are then extended, if required, to provide increased clearance for moving the gantry away from the load L, and the machine 20 is driven away from the load.

Maneuvering during all phases of gantry transport are greatly facilitated by (1) the tight turning radius provided by the triangulated nature of the gantry 20 and, (2) the infinite steering angle provided by the steering systems 68 connecting the boom bases 50, 50a to the lift leg bases 52, 52a. The machine 20 is also extremely stable during this transport due to the true planar support provided by the 3-point support and by the fact that any lateral rocking motion of the machine 20 must occur about the extended width of the machine (typically about 15′ during a load transport operation) as opposed to a much narrower 4′ width of the typical gantry.

While a particular embodiment of the invention has been shown and described, it will become apparent to those skilled in the art that changes and modifications may be made without departing from the invention in its broader aspects, and, therefore, the aim in the appended claims is to cover all such changes and modifications as fall within the true spirit and scope of the invention.

I claim:

1. A triangulated mobile gantry comprising:
(A) first, second, and third booms, each of which comprises a mobile base that is independently supported on the ground and a vertically extendible lift leg supported on said base and a having an upper end, said first boom being positioned laterally between and longitudinally remote from said second and third booms; and
(B) a plurality of horizontal beams that functionally interconnect said lift legs.

2. The gantry as recited in claim 1, wherein said beams include first, second, and third beams functionally interconnecting said upper ends of said lift legs to form an at least essentially triangular shape when viewed in top plan.

3. The gantry as recited in claim 2, wherein said first and second beams are extendible to increase the spacing between said first and second booms and said first and third booms, respectively.

4. The gantry as recited in claim 3, wherein each of said fist and second beams comprises a telescoping tube assembly comprising at least one inner tube and at least one outer tube slidable over the inner tube.

5. The gantry as recited in claim 4, where each of said first and second beams comprises a single inner tube positioned at least generally centrally of said beam, a first outer tube extending from said inner tube to the lift leg of said first boom, and a second outer tube extending from said inner tube to the lift leg of the associated one of said second and third booms, each of said outer tubes being extendible and retractable relative to said inner tube.

6. The gantry as recited in claim 5, wherein each of said first and second beams further comprises a pair of cylinders, each of which is operable to extend and retract one of said outer tubes relative to said inner tube.

7. The gantry as recited in claim 2, wherein said third beam is extendible to increase the spacing between said second and third booms.

8. The gantry as recited in claim 7, wherein said third beam comprises a hydraulic cylinder extending between said first and second beams.

9. The gantry as recited in claim 2, wherein each of said first and second beams has multiple mounting points in the vicinity of said second and third booms, respectively, for selectively receiving an associated end of said third beam at one of a plurality of discrete mounting locations.

10. The gantry as recited in claim 1, wherein said first boom comprises a front boom located adjacent a lateral centerline of said machine and said second and third booms are rear booms located on opposite sides of said lateral centerline.

11. The gantry as recited in claim 1, wherein each of said mobile bases comprises a wheel.

12. The gantry as recited in claim 1, wherein each of said bases is rotatable through an angle of 360° relative to the associated lift leg.

13. A triangulated mobile gantry comprising:
(A) first, second, and third booms, each of which comprises a mobile base and a vertically extendible lift leg supported on said base and a having an upper end, said mobile base being rotatable through an angle of at least 360° with respect to said lift leg to steer said gantry, wherein
(1) said first boom is a front boom positioned at a lateral centerline of said gantry;
(2) said second and third booms are rear booms positioned on opposite sides of said lateral centerline;
(B) first and second lift beams functionally interconnecting the lift legs of said first and second booms and said first and third booms, respectively; and
(C) a rear cross beam functionally interconnecting the lift legs said second and third booms to one another.

14. The gantry as recited in claim 13, wherein
said first and second lift beams are extendible to increase the spacing between said first and second booms and said first and third booms, respectively, wherein
each of said first and second lift beams comprises a single inner tube positioned at least generally centrally of said beam, a first outer tube extending from said inner tube to the lift leg of said first boom, and a second outer tube extending from said inner tube to the lift leg of the associated one of said second and third booms, each of said outer tubes being extendible and retractable relative to said inner tube.

15. The gantry as recited in claim 14, wherein each of said first and second lift beams further comprises a pair of cylinders, each of which is operable to extend and retract one of said outer tubes relative to said inner tube.

16. The gantry as recited in claim 13, wherein said rear cross beam comprises a hydraulic cylinder extending between said first and second lift beams and operatively connectable to each of said fist and second lift beams at multiple discrete mounting locations.

17. A method comprising;
(A) moving a mobile triangulated gantry over a load by straddling said load with an open front end of said gantry and positioning said load longitudinally between said open front end a closed rear end, said rear end of said gantry comprising a first boom positioned laterally between and longitudinally remote from second and third booms;
(B) coupling at least one of first, second, and third horizontal beams to said load, said first, second, and third horizontal beams functionally interconnecting said first, second, and third booms to one another; and
(C) vertically extending said first, second, and third booms to lift said load.

18. The method as recited in claim 17, further comprising extending said third beam prior to said moving step so as to increase the spacing between said second and third booms sufficiently to permit a rear end of said gantry to straddle said load.

19. The method as recited in claim 18, further comprising extending said first and second beams to increase the length of said gantry.

20. The method as recited in claim 17, wherein each of said booms includes a base and a lift leg mounted on said base, and further comprising steering said vehicle by rotating the base of at least one of said booms through an angle of at least 360° with respect to the associated lift leg.
